(19) United States
(12) Patent Application Publication
(10) Pub. No.: US 2012/0301821 A1
(43) Pub. Date: Nov. 29, 2012

(54) METHOD FOR PRODUCING TONER

(75) Inventors: Bo Young Kim, Seoul (KR); Dae Il Hwang, Daejeon-city (KR); Sung Yul Kim, Cheongju-si (KR); Il Sun Hwang, Daejeon-city (KR); Dong Won Kim, Incheon-city (KR); Sung Soon Kim, Gwangmyeong-si (KR)

(73) Assignee: SAMSUNG FINE CHEMICALS CO., LTD., Ulsan (KR)

(21) Appl. No.: 13/576,494

(22) PCT Filed: Feb. 1, 2011
(86) PCT No.: PCT/KR11/00735

§ 371 Date: Aug. 1, 2012

(30) Foreign Application Priority Data
Feb. 5, 2010 (KR) 10-2010-0011177

(51) Int. Cl. G03G 9/087

(52) U.S. Cl. 430/137.14

(57) ABSTRACT

Disclosed is a method of producing toner. According to the method, a concentration of a dispersion stabilizer, a concentration of an aggregating agent, and a concentration of a hydrogen ion in a reaction solution of an aggregation process are controlled to produce toner particles having a narrow particle size distribution and excellent fixability, and providing a high quality image.

### TECHNICAL FIELD

The present invention relates to a method of producing toner, and more particularly, to a method of producing toner that has a narrow particle size distribution, excellent fixability, and a high image-forming quality.

### BACKGROUND ART

Typically, toner is prepared by adding a colorant, a releasing agent, a charge controller, or the like to a thermoplastic resin that functions as a binder resin. Also, to provide fluidity to toner or to improve charge controlling or cleaning of toner, inorganic metal fine powder, such as silica or titanium oxide, may be added as an external additive to toner. As a method of preparing such toners, a physical method, such as pulverization or the like, a chemical method, such as suspension polymerization, emulsion aggregation, or the like, may be used.

From among various methods, a polymerization method uses radical polymerization, and thus, only a vinyl-based resin may be used as a binder resin. In this case, however, it is difficult for polymerization to be completely terminated and thus a non-reacted monomer, a surfactant, or the like may remain in toner particles, and thus, charge characteristics of the toner particles may be degraded.

A polyester resin has better pigment dispersibility, better transparency characteristics, a lower fixing temperature, and a narrower range of glass transition temperatures than a vinyl-based resin, such as a styrene-acryl-based copolymer resin. Due to these advantages, a polyester resin is suitable for use as a binder resin for toner for a high-speed printer or a color printer.

According to an example of a method of preparing toner using a polyester resin as a binder resin, polyaluminum chloride (PAC) as an agglomerating agent is used together with a mixed solution including a polyester resin dispersion, a colorant dispersion, and a wax dispersion to aggregate toner particles, and then freezing/fusing is performed. When polyaluminum chloride is used as a agglomerating agent, it is difficult to deactivate the polyaluminum chloride through a pH change of a reaction solution during the freezing, and also, removal of the agglomerating agent during washing and drying may also be difficult. Thus, these difficulties may adversely affect charging of toner.

Also, in preparing a polyester resin dispersion, ammonia water may be used as a dispersion stabilizer. In this case, however, the unpleasant odor of the ammonia water may remain in a produced toner.

### DETAILED DESCRIPTION OF THE INVENTION

### Technical Problem

The present invention provides a method of preparing toner having a narrow particle size distribution and excellent fixability, and providing a high quality image by using a polyester resin as a binder resin.

### Technical Solution

According to an aspect of the present invention, provided is a method of preparing toner, wherein the method includes: mixing a polyester resin dispersion, a colorant dispersion, and a wax dispersion to prepare a mixture; aggregating toner particles by adding an aggregating agent to the mixture; and fusing the aggregated toner particles, wherein an inorganic base is used as a dispersion stabilizer which is added to the polyester resin dispersion, an inorganic salt is used as the aggregating agent used in the aggregation process, and a concentration of a monovalent metal ion of the inorganic base, a concentration of a trivalent metal ion of the inorganic salt, and a concentration of a hydrogen ion of an acid used in the aggregation process satisfy the following equations:

−11<log{[M₁⁺]·[M₂³⁺]·[H⁺]}<−6 <Equation 1>

wherein [M₁⁺] is a molar concentration of the monovalent metal ion in the reaction solution of the aggregation process,

[M₂³⁺] is a molar concentration of the trivalent metal ion in the reaction solution of the aggregation process, and

[H⁺] is a molar concentration of a hydrogen ion in the reaction solution of the aggregation process.

According to an embodiment of the present invention, the inorganic base used as the dispersion stabilizer may be NaOH, KOH, or LiOH.

According to an embodiment of the present invention, the inorganic salt used as the aggregating agent may be AlCl₃ or FeCl₃.

According to an embodiment of the present invention, wherein the polyester resin may have a weight average molecular weight of 6,000 to 80,000 and a glass transition temperature of 50 to 80° C.

### Advantageous Effects

A preparation method according to the present invention may provide toner particles having a narrow particle size distribution and excellent fixability, and providing a high quality image.

### DESCRIPTION OF THE DRAWINGS

Hereinafter, exemplary embodiments of the present invention are described in detail below.

A method of producing toner according to an embodiment of the present invention includes: mixing a polyester resin dispersion, a colorant dispersion, and a wax dispersion to prepare a mixture; aggregating toner particles by adding an aggregating agent to the mixture; and fusing the aggregated toner particles, wherein an inorganic base is used as a dispersion stabilizer that is added to the polyester resin dispersion, an inorganic salt is used as the aggregating agent used in the aggregation process, and a concentration of a monovalent metal ion of the inorganic base, a concentration of a trivalent metal ion of the inorganic salt, and a concentration of a hydrogen ion of an acid used in the aggregation process satisfy the following equations:

−11<log{[M₁⁺]·[M₂³⁺]·[H⁺]}<−6 <Equation 1>

wherein

[M₁⁺] is a molar concentration of the monovalent metal ion in the reaction solution of the aggregation process,

[M₂³⁺] is a molar concentration of the trivalent metal ion in the reaction solution of the aggregation process, and

[H⁺] is a molar concentration of the hydrogen ion in the reaction solution of the aggregation process.

The toner preparation method may further include washing and drying the fused toner particles.

The toner preparation method may be described in detail below with four processes: (A) a dispersion preparation process, (B) an aggregation process, (C) freezing and fusing processes, and (D) washing and drying processes.

(1) Dispersion Preparation Process

The dispersion preparation process includes a polyester resin dispersion preparation process, a colorant dispersion preparation process, and a wax dispersion preparation process.

A polyester resin dispersion is prepared as follows: an aqueous phase is prepared, and then an organic phase including a polyester resin is prepared, and then the aqueous phase and the polyester resin organic phase are mixed by stirring.

The aqueous phase may include a polar solvent, a surfactant, and a dispersion stabilizer.

The organic phase may include a polyester resin and an organic solvent.

As an inorganic base used as the dispersion stabilizer, NaOH, LiOH, KOH, or the like may be used.

The polar solvent may be water, methanol, ethanol, butanol, acetonitrile, acetone, ethyl acetate, or the like. For example, the polar solvent may be water.

The polyester resin according to an embodiment of the present invention may have a weight average molecular weight of 6,000 to 80,000, and an acid value of 10 to 20 mgKOH/g.

The polyester resin may be prepared by polycondensation of an acid component and an alcohol component, and a typical example of the acid component is a polyvalent carboxylic acid and a typical example of the alcohol component is a polyhydric alcohol.

Examples of the polyhydric alcohol are polyoxyethylene-(2,0)-2,2-bis(4-hydroxyphenyl)propane, polyoxypropylene-(2,0)-2,2-bis(4-hydroxyphenyl)propane, polyoxypropylene-(2,2)-polyoxyethylene-(2,0)-2,2-bis(4-hydroxyphenyl)propane, polyoxyethylene-(2,3)-2,2-bis(4-hydroxyphenyl)propane, polyoxypropylene-(6)-2,2-bis(4-hydroxyphenyl)propane, polyoxypropylene-(2,3)-2,2-bis(4-hydroxyphenyl)propane, polyoxypropylene-(2,4)-2,2-bis(4-hydroxyphenyl)propane, polyoxypropylene-(3,3)-2,2-bis(4-hydroxyphenyl)propane, polyoxyethylene-(6)-2,2-bis(4-hydroxyphenyl)propane, ethylene glycol, 1,3-propylene glycol, 1,2-propylene glycol, 1,4-butylene glycol, 1,3-butylene glycol, glycerol, and polyoxypropylene. Examples of the polyvalent carboxylic acid are an aromatic polybasic acid, an alkyl ester thereof, and a combination thereof, which are typically used in preparing a polyester resin. Examples of the aromatic polybasic acid are a terephthalic acid, an isophthalic acid, a trimellitic acid, a pyromellitic acid, a 1,2,4-cyclohexanetricarboxylic acid, a 2,5,7-naphthalenetricarboxylic acid, a 1,2,4-naphthalenetricarboxylic acid, a 1,2,5-hexanetricarboxylic acid, a 1,2,7,8-octanetetracarboxylic acid, an alkyl ester of these carboxylic acids, and a combination thereof, wherein the alkyl may be methyl, ethyl, propyl, butyl, or the like. The aromatic polybasic acid and the alkyl ester may be used alone or in combination.

Also, a glass transition temperature of the polyester resin may be in a range of 50 to 80° C., for example, 50 to 75° C. If the glass transition temperature is lower than 50° C., toner prepared using particles of polyester resin may have poor preservation stability. Also, when the glass transition temperature is higher than 80° C., an offset may easily occur and in particular, during color printing, offset-related problems may be more serious.

As the organic solvent used in the organic phase, at least one selected from the group consisting of methyl acetate, ethyl acetate, isopropyl acetate, methyl ethyl ketone, dimethyl ether, diethyl ether, 1,1-dichloroethane, 1,2-dichloroethane, dichloromethane, and chloroform may be used. However, other materials may also be used as the organic solvent.

An amount of the surfactant included in the aqueous phase may be in a range of 1 to 4 parts by weight based on 100 parts by weight of the polyester resin, and an amount of the organic solvent may be in a range of 15 to 200 parts by weight based on 100 parts by weight of the polyester resin, and the amount of the dispersion stabilizer may be 2 to 3 times greater than an acid value of the polyester resin.

The colorant dispersion may be prepared by dispersing a colorant in water by using a dispersant, such as a surfactant, or by using an organic solvent. When a colorant is dispersed in water, an anionic surfactant and a non-ionic surfactant may be used as a dispersant. For example, an anionic surfactant may be used as a dispersant. Due to the use of a dispersant, pigment may be easily dispersed in water and a dispersion particle size of the pigment in toner may be reduced, thereby enabling preparation of toner with excellent characteristics. An unnecessary dispersant may be removed by a subsequent washing process.

When a colorant is dispersed by using an organic solvent, a dispersion that is prepared by using a master batch in which a pigment is kneaded with a polyester resin is used. In detail, a master batch and an organic solvent are loaded to a ball mill, and then milled for about 24 hours, and then the resultant mixture is added to water containing a surfactant and a dispersion stabilizer, thereby completing preparation of a master batch pigment dispersion. Alternatively, a colorant may be dispersed by using the same method used in preparing the polyester resin dispersion. In this case, the dispersion stabilizer used in preparing the polyester resin dispersion may also be used as a dispersion stabilizer herein.

When the master batch pigment dispersion is used, better color expression characteristics when toner is prepared may be obtained than when a pigment dispersion is used.

As the colorant, black pigment, cyan pigment, magenta pigment, yellow pigment, or a mixture thereof, which are commercially available pigments, may be appropriately selected for use.

The colorant may be used in such an amount that toner is colorized and may form a visible image by development. For example, based on 100 parts by weight of the polyester resin, an amount of the colorant may be in a range of 3 to 15 parts by weight. When the amount of the colorant is less than 3 parts by weight, coloring effect may be insufficient, and when the amount of the colorant is greater than 15 parts by weight, in the case of black toner, electric resistance is reduced, and thus, a sufficient friction charging amount may not be obtained and pollution may occur. Also, toner consumption may be increased and a developed image may have an inappropriate toner concentration.

A wax dispersion may be prepared by dispersing natural or synthetic wax in water or an organic solvent.

Wax used herein may be any one of various known wax. For example, natural wax, such as carnauba wax or rice wax, synthetic wax, such as polypropylene wax, polyethylene wax, or the like, petroleum wax, such as montan wax or the like, alcohol-based wax, ester-based wax, or the like may be used. The wax may be used alone or in combination of at least two of these.

When wax is dispersed in water, a surfactant or a dispersion stabilizer may be used, and a dispersing device, such as a high-pressure or high-speed homogenizer, or Ultimizer may be used to prepare a dispersion. When wax is dispersed in an organic solvent, the same method used in preparing the polyester resin dispersion may be used. That is, an organic solvent is added to water to which a surfactant and a dispersion stabilizer have been added to prepare a solvent emulsion, and then wax is added thereto in a solid state to prepare a dispersion. An amount of the wax of the wax dispersion may be in a range of 0.5 to 20 parts by weight, for example, 1 to 10 parts by weight, based on 100 parts by weight of the polyester resin.

(B) Aggregation Process

The dispersions prepared by the dispersion preparation process above are mixed and then an aggregating agent and an acid are added thereto while stirring to aggregate toner particles. The aggregation process may be performed at room temperature. According to some embodiments of the present invention, the aggregation process may be performed while heating up to about a glass transition temperature Tg of the polyester resin. The stirring of the dispersions may be performed by using a stirrer and a mechanical shear force to prepare agglomerated particles with uniform size and shape.

An inorganic salt used as the aggregating agent may be AlCl₃ or FeCl₃.

A concentration of a trivalent metal ion of an inorganic salt used as the aggregating agent in a reaction solution of the aggregation process may be in a range of 0.015 to 1 mM.

A concentration of a monovalent metal ion of the inorganic base used as the dispersion stabilizer in preparing the polyester resin dispersion in a reaction solution of the aggregation process may be in a range of 38 to 380 mM.

In the aggregation process, an acid is added to an aggregation reaction solution to make the reaction solution an acidic state. In this regard, the pH of the reaction solution may be in a range of 3 to 4.

In the reaction solution in the aggregation process, the concentration of a monovalent metal ion of an inorganic base used as the dispersion stabilizer, the concentration of a trivalent metal ion of an inorganic salt used as the aggregating agent, and the concentration of a hydrogen ion of an acid which is added may satisfy with Equation 1 below. Toner particles produced by using such a reaction solution may have narrow particle size distribution, fixability, and a high image-forming quality.

−11<log{[M₁⁺]·[M₂³⁺]·[H⁺]}<−6 <Equation 1>

wherein

[M₁⁺] is a molar concentration of a monovalent metal ion in a reaction solution of the aggregation process,

[M₂³⁺] is a molar concentration of a trivalent metal ion in a reaction solution of the aggregation process, and

[H⁺] is a molar concentration of a hydrogen ion in a reaction solution of the aggregation process.

When the value is smaller than −11, aggregation power is insufficient and thus, it is difficult to minimize an amount of fine powder, and when the value is greater than −6, excess aggregation may occur, and thus, coarse powder may be highly likely produced

Since the metal ion of the inorganic salt is a trivalent ion, the aggregation power is strong and thus, excellent aggregating effects may be obtained by using small amounts of an aggregating agent, thereby reducing the amount of the remaining aggregating agent, and allowing washing to be performed easily

The aggregation process may be performed by stirring the reaction solution at a temperature of 40 to 60° C. at a rate of 1 to 6 m/s.

(C) Freezing and Fusing Processes

To freeze the aggregated toner particles, the temperature of the reaction dispersion is maintained and the pH of the reaction dispersion is increased to a range of 8 to 10.

Then, the mixture including toner particles are heated to make the particle size and shape of aggregated toner particles uniform. The heating may be performed at a temperature equal to or higher than a glass transition temperature (Tg) of the polyester resin, so as to control a volume average particle size to be in a range of 6.0 to 7.0 μm, and GSDv to be equal to or less than 1.4, and by doing this, toner particles with almost uniform particle size and shape may be obtained.

Selectively, immediately before the freezing process, a polyester resin dispersion or polystyrene butylacrylate latex may be used to cover the toner particles formed by the aggregation process so that leaking of pigment or wax included within the toner particles is prevented, toner is hardened, and chargeability thereof may be improved. In this case, as the additionally used polyester resin dispersion or polystyrene butylacrylate latex, a resin dispersion that has physical properties (glass transition temperature or molecular weight) equal to or higher than those of the polyester resin dispersion used in the previous process may be used. When the Tg and a molecular weight of the polyester resin dispersion are higher than those of the polyester resin dispersion used in the previous process, Tg may be in a range of 60 to 85° C., and a molecular weight may be in a range of 10,000 to 300,000. When the toner particles prepared in the aggregation process are covered with the additionally used resin dispersion, particle sizes may be increased. In consideration of this possibility, the size of toner which is primarily aggregated is controlled and the temperature and stirring speed are maintained at appropriate levels, thereby enabling covering toner with a single-film additional resin. Then, heating is performed thereon to a temperature equal to or higher than the glass transition temperature (Tg) of the polyester resin to improve surface properties of particles: a fusing process.

(D) Washing and Drying Processes

The toner particles obtained by the fusing process are washed with water and dried. During these washing and drying processes, a mixed solution including toner is cooled to room temperature, and filtered, and a filtrate is removed therefrom and then, toner is washed with water. Washing may be performed with deionized water, such as water distilled three or more times, and the washing may be continuously performed until conductivity of the water after washing the toner reaches 5 μS/cm or less. The washing of the toner with pure water may be a batch process or a continuous process. The washing of the toner with pure water may be performed to remove unnecessary components, such as impurities that may affect a chargeability of the toner and an unnecessary aggregating agent that did not participate in the aggregation. Following the washing, the toner is dried by using a fluidized bed dryer, a flash jet dryer, or the like.

Also, an external additive may be further added to the dried toner.

Hereinafter, embodiments of the present invention are described in detail with examples, but the present invention is not limited to the examples.

### Example 1

(1) Preparation of Polyester Resin Dispersion

1) Synthesis of Polyester Resin

120 g of dimethyl terephthalate, 74 g of dimethyl isophthalate, 160 g of 1,2-propylene glycol, and 6 g of trimellitic acid were loaded into a 5-liter reactor equipped with a stirrer, a nitrogen gas inlet, a thermometer, and a cooler, and dibutyltinoxide was added thereto as a catalyst in an amount of 500 ppm based on the weight of the mixture of these monomers. Then, the mixture was heated to a temperature of 150° C. while stirred at a rate of 1 m/s, and the temperature was maintained for 8 hours. Thereafter, the temperature was increased to 200° C., and a reaction bath was subjected to reduced pressure to remove reactants that did not react and reaction by-products. A glass transition temperature (Tg) of the prepared polyester resin was 63° C. (Jade DSC+AS, Perkin Elmer), and an acid value thereof, which was measured by titration, was 12 mgKOH/g. A number average molecular weight thereof, which was measured by using a gel permeation chromatograph equipped with a RI detector (Waters 2690), was 7,800, and polydispersity index (PDI) thereof was 3.2.

The glass transition temperature, acid value, and number average molecular weight of the polyester resin were measured by using the following methods.

Glass Transition Temperature (Tg, ° C.) Measurement

The glass transition temperature of a sample was measured by using a differential scanning calorimeter (product of Jade DSC+AS, Perkin Elmer Company) as follows: a sample was heated at a heating rate of 10° C./min in a temperature range from 20° C. to 200° C., and then quickly cooled to 10° C. at a cooling rate of 20° C./min, and then heated again at a heating rate of 10° C./min.

Acid Value Measurement

An acid value (mgKOH/g) was measured as follows: a resin was dissolved in dichloromethane and cooled, and then titrated with 0.1N KOH methyl alcohol solution.

Measurement of Number Average Molecular Weight

A number average molecular weight of a binder resin was measured by gel permeation chromatography (GPC) with reference to a calibration curve obtained from a polystyrene reference sample.

2) Preparation of Aqueous Phase

600 g of deionized water, 6.66 g of alkyldiphenyloxide disulfonate (45% Dowfax 2A1), and 900 mL of 0.1N NaOH were added to a 3 L constant-temperature reactor equipped with a stirrer, and then stirring was continuously performed at a rate of 1.5 m/s until an inner temperature reached 75° C.

3) Preparation of Organic Phase

300 g of 2-butanone and 300 g of the polyester resin prepared according to the process 1) were added to a 1 L constant-temperature reactor equipped with a stirrer, and then stirring at a temperature of 75° C. at a rate of 0.5 m/s.

4) Preparation of Polyester Resin Dispersion

After the polyester resin was dissolved in the organic phase and became transparent in the process 3), the resultant was added to the aqueous phase prepared in the process 2) while stirred at a rate of 2 m/s. The stirring continued one hour more after the organic phase was completely loaded.

A particle size was measured in a solution phase by using a particle size analyzer (Microtrac). An average particle size (D50) of the prepared polyester resin dispersion was 200 nm or less, and a particle size distribution showed FWHM less than 100 nm, that is, a monodispersed distribution.

(2) Preparation of Pigment Dispersion

A pigment dispersion was prepared by physical dispersion using alkyldiphenyloxide disulfonate (45% Dowfax 2A1) as an anionic surfactant in an aqueous phase.

A pigment dispersion was prepared as follows: 540 g of cyan pigment (product of Daicolor Pigment MFG. Co. Ltd., ECB303), 27 g of anionic surfactant alkyldiphenyloxide disulfonate (45% Dowfax 2A1), and 2,450 g of distilled water were added to a 4 L reactor equipped with a stirrer, preliminary dispersion was performed thereon for about 5 hours, and then dispersion using an ultimizer (ARMSTEC IND. CO., LTD) under a pressure of 1500 bar until a particle size was 200 nm or less was performed. As a result, a pigment dispersion having a particle size of 170 nm (microtrac measurement) was obtained.

(3) Preparation of Wax Dispersion

Like the preparation for pigment dispersion, a wax dispersion was prepared as follows: 94.4 g of anionic surfactant alkyldiphenyloxide disulfonate (45% Dowfax 2A1), 2000 g of distilled water, and 850 g of wax (Japan NOF Company, WE-5) were added to a 5 L reactor, the temperature was increased to 80° C. or higher, and then the mixture was stirred for 2 hours. After the wax dissolved, dispersion was performed thereon by using a HOMO (Niro-Soavi) device under a pressure of 600 bar for 2 hours. The dispersion temperature was 15° C. higher than the melting point of the wax. The particle size of the prepared wax dispersion obtained by the dispersion was 220 nm (microtrac measurement).

(4) Aggregating/Freezing/Fusing

The polyester resin dispersion, the pigment dispersion, and the wax dispersion, which were prepared above, were mixed. An inorganic acid (0.3 M nitric acid solution) in an amount of making the mixture have a pH of 3 or 4, and AlCl₃ (0.05 wt % based on a solid content of the aggregation reaction solution) were added to the mixture, and then aggregation was performed. In this regard, a solid content mass ratio of the polyester resin dispersion, the pigment dispersion, and the wax dispersion was 85:7:8, and the total solid content of the reaction solution was 13 wt %. An amount of NaOH included in the polyester resin dispersion was 0.15 wt % based on the solid content of the reaction solution. A pH of the reaction solution was controlled to be about 4.0.

An average particle size (d50) of the obtained toner was 6.5±0.5 μm, GSDv of the toner was less than 1.25, and GSDp of the toner was less than 1.3. The average particle size and the particle distribution were measured by using a coulter counter (Beckman Coulter).

While the aggregation temperature was maintained constant, 1.0 N NaOH solution having an amount of 70% of the equivalent of the aggregating agent and, a 0.5 M EDTA solution having a pH of 8 or more and an amount 2.5 times greater than the molar equivalent of the aggregating agent were added thereto, and then stirred.

Then, the temperature was increased to 95° C. or more and the fusing process was performed thereon until circularity of the toner reached 0.985 or more.

(D) Washing and Drying Processes

The toner particles were sieved through a mesh, and then, the surfactant and the aggregating agent were removed by a base washing and an acid washing. The washing processes continued until electric conductivity of washing solutions was 5 μS/cm or less. The wet cake of toner which had been completely washed was dried by using a flash jet drier or a fluid bed drier until the percentage of moisture content was less than 1%.

### Examples 2 to 3 and Comparative Examples 1 to 3

Tone particles were prepared in the same manner as in Example 1, except that an amount of NaOH, and an amount of AlCl₃, which were used in preparing the polyester resin dispersion, a pH of the reaction solution in aggregation process, and a freezing aggregation condition were changed as shown in Table 1 below.

In Table 1, ∘ indicates a case in which conditions for an aggregating reaction solution satisfies with Equation 1, and X indicates a case in which conditions for an aggregating reaction solution do not satisfy with Equation 1.

TABLE 1

| | Amount of | | | |
|---|---|---|---|---|
| | NaOH | Amount of | PH of | |
| | (%, WT), | AlCl₃ (%, WT), | reaction | Aggregating |
| | [mM] | [mM] | solution | conditions |
| Example 1 | 1.18/38.35 | 0.05/0.49 | 3.0 | ◯ |
| Example 2 | 2.36/76.7 | 0.075/0.73 | 4.0 | ◯ |
| Example 3 | 7.9/256.75 | 0.025/0.24 | 4.0 | ◯ |
| Comparative | 1.18/38.35 | 0.001/0.01 | 7.0 | X |
| Example 1 | | | | |
| Comparative | 2.36/76.7 | 0.005/0.05 | 7.0 | X |
| Example 2 | | | | |
| Comparative | 7.9/256.75 | 1/9.75 | 2.0 | X |
| Example 3 | | | | |
| Comparative | 1.18/38.35 | 3/29.25 | 2.0 | X |
| Example 4 | | | | |

In the table above, wt % of the amounts of NaOH and AlCl₃ was based on a solid content of the reaction solution in the aggregation process.

Toner particles obtained the above examples and comparative examples were evaluated by using the following method, and results thereof are shown in Table 2.

Evaluation on particle size distribution of final toner particles

⊚: d50(v) 6.0˜7.0 μm, GSDp <1.30, GSDv <1.25,
% of <3 μm(n) <3.0%

∘: d50(v) 6.0˜7.0 μm, GSDp <1.40, GSDv <1.35,
% of <3 μm(n) <4.0%

Δ: d50(v) 6.0˜7.0 μm, GSDp >1.40, GSDv >1.35,
% of <3 μm(n) <5.0%

x: d50(v) <7.0 μm, GSDp >1.40, GSDv >1.35,
% of <3 μm(n) <5.0%

An average particle size of toner particles was measured by using Counter III (Backman Coulter Inc.), and 50000 particles were counted and an aperture used was 100 μm.

The circularity of toner particles was measured by using FPIA-3000 (Malvern, Britain). Regarding the circularity measurement using FPIA-3000, samples were prepared by adding an appropriate amount of a surfactant to 5 to 30 ml of distilled water and adding 5 to 20 mg of toner particles thereto, and then dispersing for 1 minute in an ultrasonic dispersion device was performed.

Circularity was automatically calculated according to the following Equation 2 in FPIA-3000.

$$Circularity = \frac{2 \sqrt{area \times π}}{perimeter} \qquad 〈 Equation 2 〉$$

In the equation above, the area indicates an area of projected toner, and the perimeter indicates a circumference of a circle having the same area as that of projected toner. The circularity value may be in a range of 0 to 1, and a value approaching 1 indicates a shape similar to a circle.

Fluidity and chargeability were evaluated using Hosokawa Micron Powder Characteristics Tester PT-S and q/m meter of EPPING PES-Laboratorium.

⊚: Fluidity and chargeability were all superior; fluidity>90, chargeability<−100 μq/g

◯: Fluidity or chargeability was superior

x: Fluidity and chargeability were all inferior; fluidity<80, chargeability>−60 μq/g

Gloss: Gloss was measured by using a gloss meter (micro-Tri-gloss) (TRICOR Systems Inc.).

8≦gloss<10: ⊚

6≦gloss<8: ◯

gloss<6: Δ

Image Density Evaluation

The image density evaluation was performed by using a remodeled CLP-510(Samsung) device, which is a digital full color printer. An image density was measured by using a SpectroEye (GretagMacbeth Company), which is a spectrophotometer.

OK: 1.3 or more of image density

NG: less than 1.3 of image density

TABLE 2

| | Final | | | |
|---|---|---|---|---|
| | Particle size | Fluidity & | Image | |
| | distribution | chargeability | density | Gloss |
| Example 1 | ⊚ | ⊚ | OK | ⊚ |
| Example 2 | ◯ | ◯ | OK | ◯ |
| Example 3 | ◯ | ◯ | OK | ◯ |
| Comparative | X | X | — | — |
| Example 1 | | | | |
| Comparative | Δ | X | — | — |
| Example 2 | | | | |
| Comparative | Δ | X | — | — |
| Example 3 | | | | |
| Comparative | X | X | — | — |
| Example 4 | | | | |

When toner showed Δ or x of final particle size distribution, the toner was tested in terms of only chargeability and fluidity, and image evaluation (image concentration and gloss) was not performed thereon.

Toner particles that satisfied with Equation 1 had a particle size distribution of a predetermined level or more. However, otherwise, although a predetermined level of d50 was able to be obtained, fine powder content exceeded a predetermined reference level, and thus, GSDp and GSDv showed relatively high values.

As shown in Table 2 above, toner particles prepared by using a method according to an embodiment of the present invention have a narrow particle size distribution and excellent fixability, and provide a high quality image. While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of producing toner, the method comprising:
mixing a polyester resin dispersion, a colorant dispersion, and a wax dispersion to prepare a mixture;
aggregating toner particles by adding an aggregating agent to the mixture; and
fusing the aggregated toner particles, wherein an inorganic base is used as a dispersion stabilizer which is added to the polyester resin dispersion, an inorganic salt is used as the aggregating agent used in the aggregation process, and a concentration of a monovalent metal ion of the inorganic base, a concentration of a trivalent metal ion of the inorganic salt, and a concentration of a hydrogen ion of an acid used in the aggregation process satisfy the following equations:
−11<log{[M₁⁺]·[M₂³⁺]·[H⁺]}<−6 <Equation 1>
wherein
[M₁⁺] is a molar concentration of the monovalent metal ion in a reaction solution of the aggregation process,
[M₂³⁺] is a molar concentration of the trivalent metal ion in the reaction solution of the aggregation process, and
[H⁺] is a molar concentration of the hydrogen ion in the reaction solution of the aggregation process.

2. The method of claim 1, wherein the dispersion stabilizer is NaOH, LiOH or KOH.

3. The method of claim 1, wherein the aggregating agent is AlCl₃ or FeCl₃.

4. The method of claim 1, wherein a concentration of the monovalent metal ion of the inorganic base used as the dispersion stabilizer in the reaction solution of the aggregation process is in a range of 38 to 380 mM.

5. The method of claim 1, wherein a concentration of the trivalent metal ion of the inorganic salt used as the aggregating agent in the reaction solution of the aggregation process is in a range of 0.015 to 1 mM.

6. The method of claim 1, further comprising washing and drying toner particles, following the fusing.

7. The method of claim 1, the polyester resin dispersion is prepared by adding an organic phase to an aqueous phase, and then stirring the mixture, wherein the aqueous phase comprises a surfactant, a polar solvent, and a dispersion stabilizer, and the organic phase comprises a polyester resin and an organic solvent.

8. The method of claim 1, wherein, the polyester resin has a weight average molecular weight of 6,000 to 80,000, and a glass transition temperature of 50 to 80° C.
